(19) United States
(12) Patent Application Publication
(10) Pub. No.: US 2025/0290782 A1
(43) Pub. Date: Sep. 18, 2025

(54) GAS FLOW METER FOR LOW PRESSURE AND LOW TEMPERATURE SERVICE

(71) Applicant: JEFFERSON SCIENCE ASSOCIATES, LLC, NEWPORT NEWS, VA (US)

(72) Inventors: KEVIN JORDAN, NEWPORT NEWS, VA (US); GEORGE BIALLAS, YORKTOWN, VA (US); MICHAEL TIEFENBACH, Poquoson, VA (US); CHRISTIANA WILSON, NEWPORT NEWS, VA (US); JOSEPH GUBELI, GLOUCESTER, VA (US); GARY CROKE, NEWPORT NEWS, VA (US); DAKOTA CHRISTIAN, NORFOLK, VA (US)

(21) Appl. No.: 18/602,176

(22) Filed: Mar. 12, 2024

Related U.S. Application Data
(60) Provisional application No. 63/441,017, filed on Jan. 25, 2023.

(51) Int. Cl. G01F 1/696; G01F 15/04; H01P 7/06

(52) U.S. Cl. CPC G01F 1/6965; G01F 15/043; H01P 7/06

(57) ABSTRACT

A gas flow meter for all pressures, including fractions of an atmosphere, and for cryogenic temperature systems such as cryomodules for cooling superconducting radio frequency cavities in a particle accelerator. An accurate measurement is critical to determine the quality factor (Q₀) of the superconducting cavities. The instrument head, including a superconducting material adjacent to an electric resistance heater, measures gas flow. The power in the heater is increased until the superconductor exhibits ‘normal’ conducting voltage (quench) while an electric current passes through it. The heater power required to drive the superconductor to quench is a function of the gas flow passing the instrument head. Digital control and readout of all critical elements are supplied by a digital control system interfacing to an analogue to digital, digital to analogue (AtoD DtoA) module.

This application claims the priority of Provisional U.S. Patent Application Ser. No. 63/441,017 filed Jan. 25, 2023, the contents of which are incorporated herein by reference in their entirety.

The United States Government may have certain rights to this invention under Management and Operating Contract No. DE-AC05-06OR23177 from the Department of Energy.

### BACKGROUND OF THE INVENTION

There has been a need to determine the mass flow of gaseous helium from a vacuum bottle that contains one or more superconducting radio frequency (SRF) cavities (generally called a cryomodule) at 2° Kelvin. An accurate measurement is critical to determine power boiling its liquid helium and from that, the quality factor (Q₀) of its superconducting cavities. This measurement ability also serves as an early warning device to determine an increase in the heat load of a cryogenic system, an example would be deterioration of the insulating vacuum.

### BRIEF SUMMARY OF THE INVENTION

The invention is a gas flow meter for all pressures, including fractions of an atmosphere, and for cryogenic temperature systems, such as cryomodules for cooling SRF cavities for a particle accelerator. In such a system there has been a long-felt need to accurately determine the mass flow of return helium gas from a cryomodule at 2° to 9° Kelvin. An accurate measurement is critical to determine the quality factor (Q₀) of the superconducting cavities.

The instrument head of this device is installed in a pipe conveying cryogenic temperature gas from 2 K (−456° F.) to 91 K (−296° F.) and all pressures, including fractions of an atmosphere. . . . The instrument measures gas flow. The instrument head consists of a superconducting material adjacent to an electric resistance heater. The power in the heater is increased until the superconductor exhibits ‘normal’ conducting voltage (known as “quench”) while an electric current passes through it. The heater power (and thus the heater current) required to drive the superconductor to quench is a function of the gas flow passing the instrument head. Heater current, superconductor current and voltage detection elements, as well as affiliated temperature sensor activation are located in a remote electronics chassis with current sources and voltage detection, where control and readout of the elements is facilitated by an Analogue to Digital, Digital to Analogue (AtoD DtoA) unit, with an interface to a digital control system (DCS). The present embodiment of the flow meter works with helium at a pressure of 1/30 atm and 2 to 9 K and a niobium titanium superconductor. Other embodiments of the meter would work with other cryogenic gasses, including hydrogen, nitrogen and perhaps natural gas at their low liquefaction temperatures, using other superconductors.

### BRIEF DESCRIPTION OF THE SEVERAL VIEWS OF THE DRAWING(S)

Reference is made herein to the accompanying drawings, which are not necessarily drawn to scale, and wherein:

FIG. 1 is a side view of a gas flow measurement device according to the invention.

FIG. 2 is an isometric view of a second embodiment of a gas flow measurement device according to the invention.

FIG. 3 is a block diagram of the electronics according to the invention.

### DETAILED DESCRIPTION OF THE INVENTION

The present invention is an apparatus and method for gas flow measurement at cryogenic temperature.

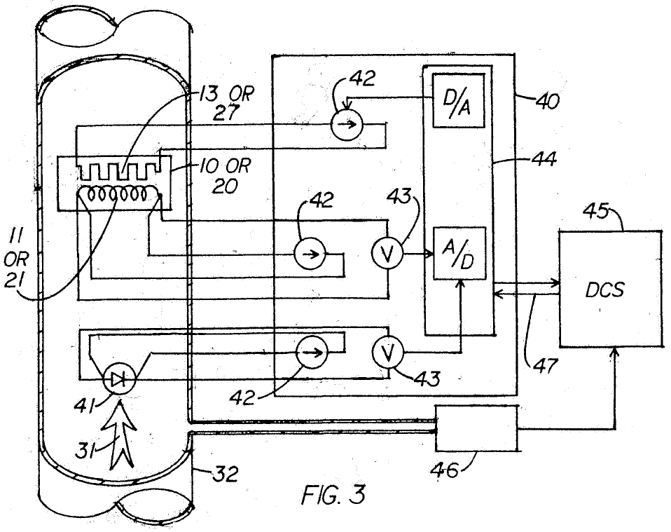

The health of superconducting cavities in a SRF accelerator needs to be monitored during operation, where internal contamination can cause unwanted, excessive heat generation, a condition known as low Q₀. This invention can detect both heat (power) generated by individual accelerating cavities and the overall power from a multi cavity cryomodule. For this SRF application, measuring actual flow is circumvented because the flow meter is calibrated as a power meter, resolving to the single watt level. The flow meter reading is calibrated in power units by using conventional calibrated electric heaters already built into the cryomodule for other purposes. This direct power calibration is usable because of the direct correspondence of the cavity power (watts) dissipated to the 2 K liquid helium cooling bath and evaporating the helium to a gas (flow) 31 (as seen in FIG. 3) that returns to a helium liquification refrigerator. The flow meter instrument head, mounted in the helium gas return pipe 32 (as seen in FIG. 3), enables these measurements of both the power dissipated by individual cavity Q₀s when the particle beam is turned off and of dissipated power in the entire cryomodule while the accelerator is operating. Other embodiments of the meter will be able to determine gas flow at cryogenic temperatures of other gasses and at various pressures and temperatures where other meters may not be available.

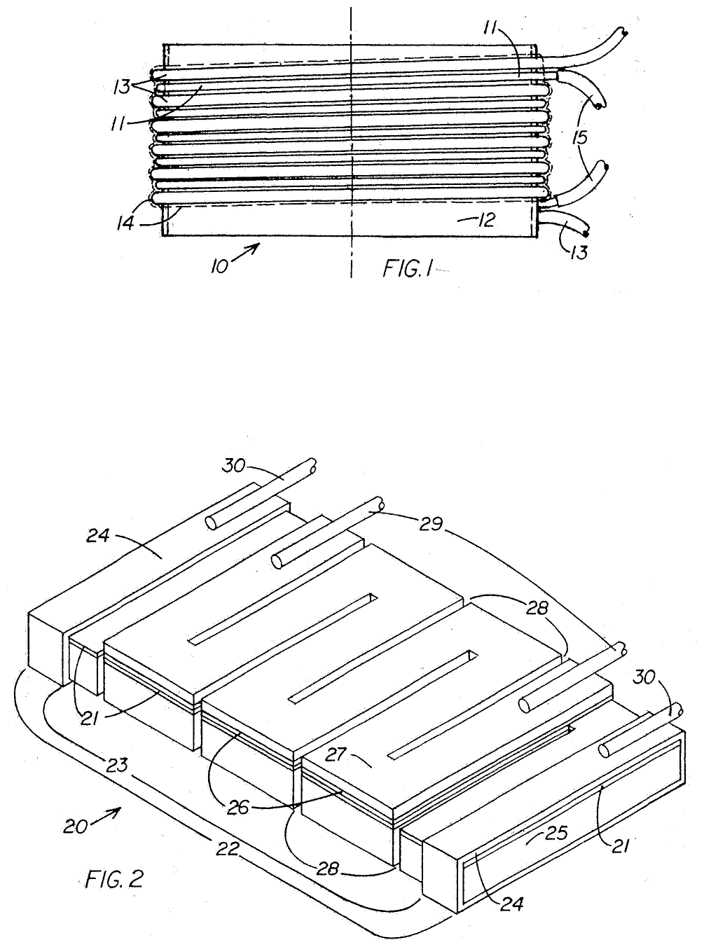

With reference to FIG. 1, a side view of a flow meter's instrument head for helium gas below 9 K is shown, according to the invention, generally designated by the reference numeral 10. It is made with an embedded, bare superconductor winding made of niobium titanium wire 11 available from Supercon of Shrewsbury, MA and an adjacent winding made of insulated electric heater wire 13, such as stainless steel or manganin. The windings are bound to the copper substrate 12 with potting resin 14, such as epoxy. Beyond the instrument head, the superconductor retains its original, highly conductive copper sheath 15 so that voltage from leads to the instrument head winding is small compared to the voltage across the superconductor when it quenches.

The instrument head 10 is mounted in a pipe 32 and exposed to the flow of the gas 31 to be measured. The gas flow 31 acts to cool the instrument head. A diode-based temperature transducer 45 (as shown in FIG. 3), such as those available from Lake Shore Cryotronics of Westerville, OH near the instrument head 10 detects the temperature of the gas flowing past the instrument head 10.

With reference to FIG. 2, the second embodiment of the gas flow measurement device, designated by the reference numeral 20, is an instrument head for higher temperature service. The instrument head for higher temperature service preferably consists of a small segment 22 of tape-shaped High Temperature Superconductor (HTS) conductor modified according to the invention. The superconductor is, as an example, yttrium, barium, copper oxide (YBCO) 21 conductor available from Superpower of Glenville, NY for use with temperatures below about 91 K. The electrically conductive copper overlayer 24 of the tape is etched away in the central portion 23 of the segment. The inner layers of the tape conductor contain a thin layer of the YBCO superconductor 21 applied to a thick stainless steel substrate 25. The electrically insulated electric heater, for this embodiment, consists of an electric insulating layer 26 and a layer of resistive alloy 27 applied over the etched portion 23 of the tape segment 22. The etched portion is slit 28 from the sides to form a serpentine, higher resistance electrical path for both the electric heater alloy 27 during powering and the YBCO superconductor layer 21 when it is quenched at higher temperatures. Electrical leads 29, to detect the quench of the superconductor are attached by soldering to the copper overlayer 24 at each end. Additional electrical leads 30 are attached by soldering to the ends of the serpentine shaped electric heater layer 27. It would be within the scope of the invention to use other high temperature superconductors for materials that flow at other low temperatures.

With respect to FIG. 3, it is a block diagram of the electronics of the invention, including the electronic chassis, designated by the reference numeral 40. It is electrically connected to the instrument head 10 or 20 and the diode temperature detector 41 in the pipe 32 through electrical feed-throughs and to the digital control system (DCS) 45 via ethernet 47.

The chassis contains current sources 42 that supply electric currents to the superconductor 11 or 21, electric heater 13 or 27, and temperature diode 41. Voltage monitor circuits 43 detect voltages across the superconductor 11 or 21 and the temperature diode 41.

An Analogue to Digital, Digital to Analogue (AtoD DtoA) Module 44, such as are available from LabJack Corporation of Lakewood, Colorado or Raspberry Pi Foundation of Cambridge, United Kingdom, is mounted in the chassis. The AtoD DtoA module 44 controls the current source 42 and voltage monitor 43 circuits with analogue signals and converts read-back signals to digital format, sending data and receiving instructions from a digital control system (DCS) 45 such as Lab View, available from National Instruments Corp. of Austin, TX or Experimental Physics and Industrial Control System (EPICS), available from Argonne National Laboratory of Lemont, IL.

A current source 42 in the electronics chassis 40 runs a small electric current through the superconductor 11 or 21. The voltage monitor circuit 43 detects nominally zero volts when the SC 11 or 21 is superconducting. The current source 42 in the electronics chassis 40 also ramps a current through the electric heater 13 or 27 from a lower value to a balance point. While simultaneously being cooled by the gas flow 31, the instrument head 10 or 20 is heated to a temperature above that of the gas where cooling is balanced against the heating (balance point), and some, or all, of the superconductor 11 or 21 is quenched, as detected by a non-zero voltage on a voltage monitor circuit 43.

The heater current at the balance point is a direct function of a unique gas flow 31 velocity at a gas temperature detected by the diode 41 passing by the instrument head 10 or 20 and the pressure detected by the pressure transducer 46 which supplies its digital data directly to the DCS 45.

The DCS 45, by means of the AtoD DtoA Module 44, stores the values of the electric heater current at the balance point and all other parameters as digital data. The logic of the DCS 45 averages the values of the electric heater current at the balance point using a number of data points, obtaining a statistically more consistent value.

A digital version of a calibration plot of flow velocity vs. averaged electric heater current vs. temperature at various pressures, as obtained by a factory calibration process, is installed in the DCS 45. For any reading, the gas density is found by interpolation from readily available temperature and pressure tabulation stored in the DCS 45. The logic of the DCS 45 is used to determine a gas flow velocity by interpolation from the digital calibration plot at the gas temperature and pressure. The DCS 45 calculates the mass flow value of the gas using the velocity, density and pipe diameter of the installation.

For low temperatures, the temperature instrument is preferably a temperature diode 41. Other temperature indicator systems and readouts may be incorporated for other gases and temperatures.

The current invention provides a method of determining the heat dissipation of SRF cavities at various accelerating gradients, characterized by the nomenclature “Q₀”, wherein an instrument head 10, according to the invention, is installed in the helium gas return pipe 32 of a cryomodule containing one or many SRF cavities, is connected to the electronics chassis 40 and uses the Accelerator's EPICS to run the DCS 45.

A flow meter, according to the invention, for the SRF Cavity application, is calibrated in power units (watts rather than flow units, g/s), as there is a direct correspondence of power dissipated into the 2 K helium bath cooling the cavities and the evaporation (hence flow going through the helium gas return pipe 32).

One of the protocols for directly finding the dissipative power generated by a single cavity or all cavities in a cryomodule records an average of the niobium titanium superconductor 11 instrument head's 10 electric heater current balance point readings with the cavity(s) turned on at an accelerating gradient. The cavity(s) are turned off, and for the duration of the next readings, the system maintains the same cryogenic temperature and pressure parameters. The calibrated cryomodule heaters are then iterated to mimic the cavity(s) dissipative power such that the averaged instrument head 10 heater current at the balance point matches that found for the cavity(s) when they were turned on. The protocol has thus found the cryomodule heater power at the matching instrument head heater current that equals the dissipative power generated by a cavity(s) at the gradient. One can calculate the Q₀ of individual cavities from this dissipative power value, the cavity gradient, and the characteristics of the cavity.

As the invention has been described, it will be apparent to those skilled in the art that the same may be varied in many ways without departing from the spirit and scope thereof. Any and all such modifications are intended to be included within the scope of the appended claims.

I claim:

1. A method of gas flow measurement comprising:
a superconductor (SC) embedded in an instrument head;
the instrument head including an electric heater adjacent to the superconductor;
the instrument head mounted in a pipe and exposed to the flow of the gas to be measured, the gas acting to cool the instrument head;
a temperature diode at the instrument head to detect the temperature of the flow of gas; and
a pressure sensor in contact with the gas to detect the local pressure.

2. The method of claim 1, comprising:
an electronics chassis;
one or more electrical circuits to connect to the instrument head and the temperature detector; and
one or more electric current sources to supply electric currents to the superconductor, electric heater and temperature diode.

3. The method of claim 2, wherein said one or more electrical circuits comprise one or more voltage detection circuits to read voltages across the superconductor and the temperature diode.

4. The method of claim 3, comprising:
an analogue to digital, digital to analogue (AtoD DtoA) module in the chassis;
the AtoD DtoA module to control the one or more electric current sources and one or more voltage detection circuits using analogue signals and converting read-back signals to digital format; and
a digital control system (DCS) to receive and send data and instructions to the AtoD DtoA module.

5. The method of claim 4, comprising:
running an electric current through the superconductor;
monitoring the voltage across the superconductor; and
detecting nominally zero volts when the superconductor is superconducting.

6. The method of claim 5, comprising:
ramping an electric heater current through the electric heater from a lower value to a balance point where cooling from the gas flow is balanced against the heating from the electric heater and at least some of the superconductor is turned normal conducting; and
detecting the non-zero voltage on the voltage detection circuit.

7. The method of claim 6, comprising:
the heater current at the balance point is a direct function of a unique gas flow velocity at a gas temperature and pressure passing by the instrument head; and
storing the value of the electric heater current in the DCS at the balance point as digital data.

8. The method of claim 7, comprising averaging the value of the electric heater current at the balance point using a number of data points to obtain a statistically more consistent value.

9. The method of claim 8, comprising:
installing in the DCS a digital version of a calibration plot of flow velocity versus average electric heater current versus gas temperature at various pressures;
using the logic of the DCS to find a gas flow velocity from the digital calibration plot;
entering the pipe diameter and the gas density into the DCS; and
generating and displaying the mass flow value of the gas.

10. The method of claim 1, comprising the superconductor in the instrument head is niobium titanium wire for temperatures below 9 K.

11. The method of claim 1, comprising the superconductor in the instrument head is a segment of yttrium barium copper oxide (YBCO) based tape for temperatures below 91 K.

12. The method of claim 10, wherein the instrument head comprises:
a copper substrate;
an insulated electric heater wire wound adjacent to the niobium titanium superconductor wire; and
said superconductor wire is bound to the copper substrate with potting resin.

13. The method of claim 12, comprising said insulated electric heater wire is stainless steel or manganin.

14. The method of claim 11, wherein the segment of YBCO based tape comprises:
an etched portion;
an insulating layer and a layer of resistive alloy applied over the etched portion; and
the etched portion is slit from the sides with cuts to form a serpentine higher resistance path.

15. The method of claim 14, comprising the etched portion creates a higher resistance zone when the YBCO is normal conducting.

16. The method of claim 1, comprising:
a cryomodule that contains one or more superconducting radio frequency (SRF) cavities at 2° Kelvin;
installing the gas flow measurement device in the flow of gaseous helium from the cryomodule; and
determining the health of the one or more superconducting cavities in one or more superconducting radio frequency (SRF) cavities at 2° Kelvin.

17. The method of claim 16, wherein said method of gas flow measurement comprises:
a flow meter calibrated as a power meter; and
the flow meter resolves to the single watt level.
